(19) United States
(12) Patent Application Publication
(10) Pub. No.: US 2023/0276998 A1
(43) Pub. Date: Sep. 7, 2023

(54) Accessory for a Kitchen Appliance

(71) Applicant: Vorwerk & Co. Interholding GmbH, Wuppertal (DE)

(72) Inventor: Nils Beckmann, Remscheid (DE)

(21) Appl. No.: 18/177,325

(22) Filed: Mar. 2, 2023

(30) Foreign Application Priority Data
Mar. 7, 2022 (EP) 22160537.1

(51) Int. Cl. A47J 43/07; H01Q 1/22

(52) U.S. Cl. CPC A47J 43/075; H01Q 1/2208

(57) ABSTRACT

The application relates to an accessory for a kitchen appliance, the kitchen appliance including a reading arrangement having a reading controller and at least one reading antenna connectable to the reading controller, the accessory including at least one transponder arrangement, wherein the transponder arrangement includes a transponder and an accessory position sensor connected to the transponder, wherein the accessory position sensor is configured to detect at least one accessory position parameter of the accessory, and wherein the transponder arrangement is configured to transmit the detected accessory position parameter to the reading arrangement.

### CROSS-REFERENCE TO RELATED APPLICATION

This application claims priority to European Patent Application No. 22160537.1 filed Mar. 7, 2022, the disclosure of which is hereby incorporated by reference in its entirety.

### BACKGROUND OF THE INVENTION

### Field of the Invention

The application relates to an accessory for a kitchen appliance. Furthermore, the application relates to a kitchen appliance and a method.

### Description of Related Art

From the prior art kitchen appliances are known, for example in the form of food processors, which are configured to prepare food at least semi-automatically. Such food processors, but also other kitchen appliances, may comprise at least one accessory, for example a pot and/or a lid of a container arrangement. Exemplary and non-exhaustive accessories comprise, in particular, a varoma, a stirring attachment, a knife cover, a measuring cup, a lid, a pot, a cooking basket and/or the like. An accessory can be coupled and connected, respectively, to the kitchen appliance, in particular to the appliance base of the kitchen appliance.

From EP 3 285 627 B1 a kitchen appliance in the form of a mixing system is known, in which an accessory coupled to an appliance base is identified with the aid of RFID (radio frequency identification). For this purpose, in EP 3 285 627 B1 a passive RFID transponder with a readable accessory identifier is provided in the accessory and an RFID reading arrangement for reading the RFID transponder (for example an NFC (Nearfield Communication) transponder) is provided in the appliance base.

A disadvantage of the prior art is that the identification of the accessory can be performed without ensuring that the accessory is properly respectively correctly positioned on the kitchen appliance, in particular the appliance base. Thus, regardless of the operating position of the accessory, the RFID transponder is always read when the RFID transponder is within range of the RFID reading arrangement. However, for safe operation of the kitchen appliance, a kitchen appliance function should not be released until the accessory has been properly coupled and correctly positioned, respectively, with the appliance base and/or a further accessory. In particular, improper positioning may result in a damage of the kitchen appliance and/or the accessory.

### SUMMARY OF THE INVENTION

Therefore, the object of the application is to provide a possibility with which a kitchen appliance can be operated in a safe manner and, in particular, damages of the kitchen appliance and/or the accessory can be reduced.

This object is solved according to a first aspect of the application by an accessory for a kitchen appliance according to claim 1. The kitchen appliance comprises a reading arrangement having a reading controller and at least one reading antenna connectable to the reading controller. The accessory comprises at least one transponder arrangement. The transponder arrangement comprises a transponder and an accessory position sensor connected to the transponder. The accessory position sensor is configured to detect at least one accessory position parameter of the accessory. The transponder arrangement is configured to transmit the detected accessory position parameter to the reading arrangement.

In that, in contrast to the prior art, according to the application the accessory is equipped with a readable transponder arrangement, wherein the transponder arrangement comprises an accessory position sensor connected to a transponder, wherein the sensor detects at least one accessory position parameter, a correct positioning of the accessory can be detected in a kitchen appliance. This can improve the operational reliability of the kitchen appliance. Damages of the kitchen appliance and/or the accessory due to improper positioning of the accessory on the kitchen appliance can be reduced.

The accessory according to the application is configured for use in a kitchen appliance. The kitchen appliance is in particular a food processor configured to prepare food. The preparing may be at least partially automated. Preferably, the kitchen appliance may be configured to prepare, at least partially automatedly, cold dishes and hot dishes.

The at least one accessory according to the application can preferably be an accessory selected from the group comprising
knife cover,
stirring attachment,
lid,
lid with additional function, e.g. cutting device for vegetables
pot,
measuring cup,
cooking basket, and/or
varoma.

Preferably, a kitchen appliance may comprise a container arrangement. The container arrangement may comprise at least one pot and at least one first lid structurally corresponding to the pot. This means, in particular, that a (pot) opening can be closed and covered, respectively, by the first lid and the lid can be, in particular, placeable on the pot opening.

According to the application, a pot, also called a cooking pot, means in particular a fillable container and a fillable vessel, respectively, which is configured to prepare food, in particular to cook or boil hot food. Preferably, the pot corresponds (structurally) to an appliance base of the kitchen appliance.

For example, an accessory may be formed at least partially of plastic, at least partially of metal, and/or at least partially of glass.

According to the application, a lid means in particular at least one closure element and/or cover element with which the opening of the pot can be (completely) closed and covered, respectively. The lid may in turn have a lid opening, for example for coupling with a further accessory. In variants of the application, the lid may have additional functions, such as a cutting function.

According to the application, the lid can be locked to the pot. In particular, the first lid is movable relative to the pot between an unlocked position and a (defined) locked position. In the locked position, the lid and the container arrangement, respectively, is in a (mechanical) locking state. The locking according to the application is in particular a mechanical locking and blocking, respectively, of the lid.

At least one further accessory may be arrangeable in the pot, such as a cutting tool and/or a stirring tool.

In particular, an accessory according to the application is configured to (direct and/or indirect) position on an appliance base of the kitchen appliance. For example, the accessory can be positioned directly on the appliance base, in particular coupled thereto. Alternatively, the accessory is positional, in particular couplable, to a further accessory that is (directly or indirectly) arranged respectively positioned on the appliance base.

The kitchen appliance comprises a reading arrangement. The reading arrangement comprises a reading controller and at least one reading antenna connectable to the reading controller. The reading arrangement may be at least partially integrated in an appliance base of the kitchen appliance and/or at least partially integrated in the accessory. In particular, the reading controller (in particular comprising an evaluation module) may be integrated in an appliance base of the kitchen appliance or in the accessory (e.g. pot). In one embodiment, only the evaluation module can also be integrated in the accessory and the rest of the reading controller in the appliance base.

The accessory comprises a transponder arrangement. The transponder arrangement comprises at least one transponder that can be read wirelessly and contactlessly, respectively. In particular, the transponder is readable by said reading arrangement. In particular, the transponder corresponds to the reading arrangement.

According to the application, the transponder is connected to and/or comprises at least one accessory position sensor. The at least one accessory position sensor is configured to detect at least one accessory position parameter of the accessory. In particular, an (instantaneous) accessory position parameter and an (instantaneous) accessory position parameter value, respectively, can be measured by the accessory position sensor.

Preferably, the at least one accessory position parameter can be a transverse axis angle, a longitudinal axis angle and/or a vertical axis angle. A transverse axis means in particular the body axis which is transverse to the longest extension of a body (e.g. accessory, appliance base, etc.). The angle of rotation about this axis is in particular the transverse axis angle. A longitudinal axis is to be understood in particular as the body axis corresponding to the direction of the greatest extension of a body (e.g. accessory, appliance base, etc.). The angle of rotation about this axis is in particular the longitudinal axis angle. A vertical axis is to be understood in particular as the body axis which is vertical to the longest extension of a body (e.g. accessory, appliance base, etc.). The angle of rotation about this axis is in particular the vertical axis angle.

As has already been described, the transponder arrangement according to the application comprises the transponder and the at least one accessory position sensor. This allows that by reading the transponder arrangement the at least one detected accessory position parameter can be read. In particular, the at least one accessory position sensor provides the at least one accessory position parameter to the transponder (at least upon a request by the transponder) so that in particular the at least one accessory position parameter can be read by reading the transponder. In other words, a readable transponder enables the at least one accessory position parameter to be read. Thus, the transponder arrangement is configured at least to transmit the at least one detected accessory position parameter to the reading arrangement.

According to a preferred embodiment of the accessory according to the application, the transponder can be an RFID transponder. An RFID transponder (comprising in particular also NFC transponders) can be implemented in a simple manner and at low cost. Furthermore, an RFID transponder can be read reliably.

An RFID transponder can comprise a transponder antenna coil. The transponder antenna coil can be configured to receive a reading field and interrogation field, respectively, of a reading arrangement.

Preferably, the transponder can be a passive transponder. Passive means in particular that the transponder cannot actively transmit a transmission field, but in particular can only manipulate and encode, respectively, a received reading field (depending on the information to be transmitted). Passive (further) means in particular that the transponder does not have its own energy source (e.g. battery), but is supplied with energy by the reading field and transmitting field, respectively, of the reading antenna.

As has already been described, the transponder can preferably have a coil as a receiving antenna. By induction, similar to a transformer, a capacitor of the transponder can be charged. This energy can be used by the transponder in particular to respond to a request contained in the reading field. This can provide a simple and reliable operating transponder.

According to a preferred embodiment of the accessory according to the application, the transponder may be configured to supply the accessory position sensor with electrical energy based on a received reading field of the reading antenna. As has already been described, the transponder may utilize the energy contained in the reading field. This energy may be provided, at least in part, to the at least one accessory position sensor. In particular, a respectively configured capacitor may be arranged in the transponder.

It shall be understood that in other variants of the application, the transponder arrangement may also have its own power source, such as a (rechargeable) battery. In this variant, the transponder is then capable of actively transmitting a transmission field or responding to a received reading field or received signal.

According to a further embodiment of the accessory according to the application, the transponder may comprise at least one readable (data) memory. At least one accessory identifier and/or one accessory type identifier can be stored in the memory. An accessory identifier can uniquely identify an accessory system-wide. An accessory type identifier may uniquely identify a particular accessory type from a plurality of accessory types system-wide. In a variation of the application, the accessory type identifier may be contained in the accessory identifier. In particular, the accessory identifier and/or accessory type identifier can be read by the reading controller via the reading antenna. In particular, the accessory transponder may be configured to respond to receiving a reading field containing the accessory identifier and/or accessory type identifier. In particular, the readability of the accessory identifier and/or accessory type identifier enables identification of the accessory and accessory type, respectively.

It shall be understood that in variants of the application at least one further datum can be stored in the memory and in particular can be read (e.g. at least one permissible and/or non-permissible device function of the accessory etc.).

Preferably, a specific appliance function of the kitchen appliance can be enabled for a user depending on an identified accessory and accessory type, respectively. In particular, this means that a specific appliance function can only be released if at least one specific accessory type is identified. This appliance function can be blocked respectively remain blocked if another accessory type is identified. The safety during operation of the kitchen appliance can be improved.

According to a further embodiment of the accessory according to the application, the transponder may comprise at least one readable (data) memory. In the memory, at least one calibration information of the accessory position sensor can be stored. Preferably, the calibration information of the accessory position sensor can be stored in the memory in addition to the accessory identifier and/or accessory type identifier.

In particular, it has been recognized that manufacturing-based variations may occur in the manufacture of an accessory and/or transponder arrangements. Preferably, a factory made calibration can be performed in particular for each accessory (and each kitchen appliance). This allows, for example, manufacturing-based variations to be taken into account when attaching and/or positioning the accessory position sensor to respectively in the accessory, in particular when evaluating a read accessory position parameter.

According to a preferred embodiment of the accessory according to the application, the accessory position sensor can be an acceleration sensor, in particular a 3-axis acceleration sensor. In particular, the axes may be the transverse axis, longitudinal axis and vertical axis. Preferably, the at least one accessory position parameter may be an angle of inclination of the accessory with respect to the acceleration due to gravity. For example, the angle of inclination of the accessory with respect to the acceleration due to gravity may be determined from a detected transverse axis angle, longitudinal axis angle, and/or vertical axis angle. The angle of inclination in relation to the acceleration due to gravity can then be used in a particularly advantageously way to estimate the correct positioning of the accessory.

A further aspect of the application is a kitchen appliance, in particular a food processor. The kitchen appliance comprises at least one previously described accessory. The kitchen appliance comprises a reading arrangement (described before) comprising a reading controller and at least one reading antenna connectable to the reading controller. The reading arrangement is configured at least to read the accessory position parameter from the transponder arrangement.

The reading controller is preferably an RFID reading controller. In particular, the reading controller can be an RFID reader (e.g. formed by a microcontroller). In particular, the reading antenna is an antenna coil. In particular, the antenna coil may be an RFID-based antenna coil. The antenna coil may be formed of copper. It shall be understood that other electrically conductive materials, in particular metals, may also be used, for example aluminum or the like. The number of windings of the antenna coil may preferably be between 1 and 10, more preferably between 1 and 5, most preferably in particular 3 or 4.

Preferably, the kitchen appliance may comprise an appliance base. Further, the kitchen appliance may comprise a container arrangement. As has been described, in one embodiment, the container arrangement may be an accessory and/or comprise an accessory (for example, a pot or lid).

The appliance base and/or the container arrangement and/or the accessory may comprise the reading arrangement. Preferably, the reading controller may be integrated in the appliance base, for example in the appliance controller of the appliance base. However, it is also conceivable that the accessory (e.g., a pot) comprises the reading controller.

Preferably, the at least one reading antenna may be arranged in respectively on the container arrangement, for example on respectively in the pot and/or on respectively in the lid. Also, the at least one reading antenna may be arranged in the appliance base. In variants of the application, two or more reading antennas may also be provided.

Preferably, the appliance base may comprise a pot receptacle corresponding to the pot of the container arrangement. When the reading antenna is arranged in respectively on the container arrangement, an electrical connection can be established between a first lower pot contact of the pot and a first base contact of the appliance base, and an electrical connection can be established between a second lower pot contact of the pot and a second base contact of the appliance base when the pot is disposed in the pot receptacle.

The pot receptacle is preferably configured to receive the pot, in particular at least the bottom of the pot. The pot receptacle may (structurally) correspond to the pot of the container arrangement such that an electrical connection between the first lower pot contact and a first electrical base contact of the appliance base and an electrical connection between the second lower pot contact and a second electrical base contact of the appliance base are (only) established when the pot is (correctly) arranged in the pot receptacle.

The reading controller may be electrically connected to the first base contact and second base contact. The at least one reading antenna may be electrically connectable to the lower pot contacts. For example, at least one winding may be integrated in the pot wall (e.g., formed of plastic).

In a preferred embodiment described in more detail below, the reading antenna may be arranged on respectively in the lid. In this embodiment, the lid may comprise the at least one reading antenna connected to a first lid contact and a second lid contact. The pot may comprise at least a first pot connection extending between a first upper pot contact and the first lower pot contact, and a second pot connection extending between a second upper pot contact and the second lower pot contact.

The first lid contact and the second lid contact may be arranged such that an electrical connection between the first lid contact and the first upper pot contact and an electrical connection between the second lid contact and the second upper pot contact are established only when the lid is in the locked position (i.e., when the lid is correctly positioned).

In other words, in this embodiment, a reading antenna can be arranged in or on the lid, which can only be supplied with electrical energy respectively can only be supplied with an antenna signal when the lid is in the locked position. Thus, only when the lid is in the locked position the reading antenna can transmit electromagnetic signals, in particular in the form of a reading field (also called an interrogation field). In other words, a transponder (also called a tag) of a transponder arrangement can only be read by the reading antenna of the lid when the lid is (properly) locked to the pot.

Particularly preferably, the at least one winding of the reading antenna can run along the edge of the lid and/or be bent accordingly. The at least one winding can, for example, be inserted into a lid base body during manufacturing of the lid and then provided with a cover (preferably formed from plastic). The cover may be attached to the lid base body, for example, by ultrasonic welding. In a simple manner, a reading antenna can be provided.

According to a further embodiment of the kitchen appliance according to the application, the reading controller may be configured to apply an antenna signal to the reading antenna so that a reading field and interrogation field, respectively, is transmitted by the reading antenna. The reading controller may be configured to provide the antenna signal. In particular, the reading controller can generate the antenna signal and apply it to the reading antenna so that a corresponding reading field is emitted by the reading antenna.

According to a preferred embodiment of the kitchen appliance according to the application, the reading controller may comprise an evaluation module. The evaluation module may be configured to determine an operating position of the accessory based on the read accessory position parameter and an operating position criterion.

In particular, the evaluation module can be integrated in the appliance base or the accessory, such as the container arrangement.

An operating position of the accessory means in particular a proper and correct, respectively, (direct or indirect) positioning of the accessory on the kitchen appliance, in which in particular the accessory can be used respectively operated as intended. For example, the accessory can be (properly) placed, put on, plugged on, etc. in the operating position. As has been described, a positioning of the accessory on the kitchen appliance comprises a positioning of a first accessory on a further accessory of the kitchen appliance. In one embodiment, the operating position may be a locking position in which the accessory is (mechanically) locked to the kitchen appliance respectively to a further accessory (e.g. a lid locked to a pot, as has been described).

The evaluation module may be configured to determine whether an accessory is properly respectively operably positioned respectively arranged on the kitchen appliance by evaluating the at least one read accessory position parameter. Preferably, the evaluation module can perform a comparison of the at least one read accessory position parameter (for example, an aforementioned angle, in particular an angle of inclination with respect to the acceleration due to gravity) with the operating position criterion.

The operating position criterion may define when a proper and operable, respectively, positioning is present (or when it is not present). For example, the operating position criterion can define an angular range at which proper positioning is present. If the read angle (value) is within the angle range, the evaluation module may determine that the accessory is properly positioned and arranged, respectively, on the kitchen appliance. In other words, an operating position can be determined. If the read angle (value) is not within the angle range, the evaluation module can determine that the accessory is not properly positioned and arranged respectively, on the kitchen appliance. In other words, a non-operating position can be determined.

Preferably, constructive respectively structural measures are provided on the kitchen appliance and/or the at least one accessory that allow the correct accessory position parameter (i.e., the parameter value that satisfies the operating position criterion) only at the correct operating position and, in particular, in the reading range respectively detection range of the reading antenna. This can be achieved, for example, by guide elements, such as curves, thickenings, grooves and/or recesses, on the kitchen appliance and/or the at least one accessory (e.g., an accessory in the form of a stirring attachment must be correctly placed on a further accessory in the form of a knife, otherwise the latter will fall over).

Preferably, the geometric arrangement and geometric position, respectively, of the accessory position sensor in the accessory can be known to the evaluation module. In one embodiment, the accessory position sensor can always be positioned and aligned in the same way in each accessory or at least in each type of accessory.

In a further embodiment of the kitchen appliance according to the application, the reading arrangement may be configured at least to read the accessory identifier and/or the accessory type identifier from the transponder arrangement. The evaluation module may be configured to determine the operating position of the accessory based on the accessory identifier and/or the accessory type identifier.

Preferably, an accessory type criterion can be predefined and, in particular, stored in the reading controller. The accessory type criterion can be an assignment table in which each accessory type can be assigned to a (type-specific) operating position criterion. Preferably, the respective accessory type can be a respective accessory type identifier.

The reading controller can read the accessory type identifier. The read accessory type identifier can be compared with the stored accessory type identifiers. If the reading controller, in particular the evaluation module, detects an identity between a stored accessory type identifier and the read accessory type identifier, the operating position criterion (for the described comparison) assigned to this stored accessory type identifier can be used. In a reliable way, a correct positioning of the respective accessory type can be determined even in case of different accessory types.

Further, if in the data memory of the transponder at least one calibration information is stored, the reading arrangement may preferably be configured to read the at least one calibration information. Further, the evaluation module may be configured to correct the at least one read accessory position parameter based on the at least one calibration information. The at least one corrected accessory position parameter, such as a corrected angle of inclination with respect to the acceleration due to gravity, can then be evaluated, in particular compared, for example with the operating position criterion. The reliability of the evaluation can be further improved.

According to a particularly preferred embodiment of the kitchen appliance according to the application, the kitchen appliance (in particular the appliance base) may comprise at least one kitchen appliance position sensor. The kitchen appliance position sensor may be configured to detect a kitchen appliance position parameter. In particular, the kitchen appliance position sensor may be formed like an accessory position sensor. Preferably, the kitchen appliance position sensor may be an acceleration sensor, in particular a 3-axis acceleration sensor. In particular, the axes may be the transverse axis, longitudinal axis and vertical axis. Preferably, the at least one accessory position parameter may be an angle of inclination of the kitchen appliance (in particular the appliance base) with respect to the acceleration due to gravity. For example, the angle of inclination of the kitchen appliance (in particular the appliance base) with respect to the acceleration due to gravity may be determined from a detected transverse axis angle, longitudinal axis angle, and/or vertical axis angle. The angle of inclination in relation to the acceleration due to gravity can then be used particularly advantageously to estimate the correct positioning of the kitchen appliance (in particular the appliance base).

Preferably, the operating position criterion may be based on the detected kitchen appliance position parameter. For example, the at least one instantaneously detected kitchen appliance position parameter value may form the operating position criterion. It shall be understood that a tolerance range and angular range, respectively, around the instantaneously detected kitchen appliance position parameter value may be provided.

If the accessory position sensor and the kitchen appliance position sensor are positioned respectively aligned identically, the read accessory position parameter value can be compared with the kitchen appliance position parameter value and said tolerance range, respectively, by the evaluation module. In particular, the evaluation module may be configured to compare the read accessory position parameter (in particular said accessory angle of inclination with respect to the acceleration due to gravity) with the kitchen appliance position parameter (in particular the kitchen appliance angle of inclination with respect to the acceleration due to gravity). The evaluation module may be configured to determine the correct positioning and operating position, respectively, of the accessory based on the comparison result. If the read angle (value) is within said tolerance range and angle range, respectively, the evaluation module may determine that the accessory is properly positioned and arranged, respectively, on the kitchen appliance such that it is in particular operational. In other words, an operational position can be determined. If the read angle (value) is not within the tolerance range and angle range, respectively, the evaluation module can determine that the accessory is not properly positioned and arranged, respectively, on the kitchen appliance. In particular, the accessory is not operational. In other words, a non-operational position can be determined.

In particular, the kitchen appliance position sensor enables that potential inclination of the overall system and kitchen appliance, respectively, caused for example by an inclined kitchen worktop or the like, can be taken into account during the evaluation. The reliability of the evaluation can be improved even further.

If the accessory position sensor and the kitchen appliance position sensor are not identically positioned and aligned, respectively, for an accessory type, the different alignment can be defined in particular in the accessory type criterion. In particular, one of the parameters can be normalized by means of said accessory type criterion. Thus, the accessory type criterion can be taken into account in said comparison by the fact that first the accessory type identifier is read and the associated accessory type criterion is determined based on the read accessory type identifier (as has been described).

According to a further embodiment of the kitchen appliance according to the application, the reading controller may comprise at least one (data) memory. The memory may store at least one calibration information of the kitchen appliance position sensor. In particular, it has been recognized that manufacturing-based variations may occur during the manufacturing of a kitchen appliance. Preferably, a factory made calibration can be performed in particular for each kitchen appliance. In this way, for example, manufacturing-based variations can be taken into account when attaching the kitchen appliance position sensor to respectively in the kitchen appliance (in particular the appliance base), in particular when evaluating a read accessory position parameter and the kitchen appliance position parameter value and said tolerance range, respectively.

A further aspect of the application is a method for determining the operating position of a previously described accessory. The method comprises
reading, by a reading arrangement of a kitchen appliance, the accessory position parameter of the accessory detected by the accessory position sensor, and
determining, by an evaluation module of the reading arrangement, an operating position of the accessory based on the read accessory position parameter and an operating position criterion.

In particular, the reading arrangement may be a previously described reading arrangement. Preferably, an appliance base of a previously described kitchen appliance may comprise the reading arrangement.

The method may be used to determine the operating position of a previously described accessory in a previously described kitchen appliance. Preferably, the method may further be used to identify the accessory type as previously described.

A module, arrangement or the like can be at least partially realized by hardware elements and/or software elements. In principle, data can be transmitted immediately or first collected and temporarily stored in order to be transmitted together, for example, at specific points in time. Furthermore, terms such as “above”, “top”, “bottom”, “below”, etc., refer to the direction extending vertically to a horizontal plane and to a container arrangement and/or kitchen appliance placed on a horizontal surface. Unless otherwise specified, expressions such as “first”, “second”, etc., are used only to distinguish two elements and do not indicate an order.

The features of the accessories, kitchen appliances and methods can be freely combined with each other. In particular, features of the description and/or of the dependent claims may be independently inventive, even by completely or partially circumventing features of the independent claims, in sole position or freely combined with each other.

### BRIEF DESCRIPTION OF THE DRAWINGS

There are now a multitude of possibilities to design and further develop the accessory according to the application, the kitchen appliance according to the application and the method according to the application. In this regard, reference is made on the one hand to the patent claims subordinate to the independent patent claims, and on the other hand to the description of embodiments in connection with the drawing. In the drawing shows:

FIG. 1 a schematic view of an embodiment of an accessory according to the present application,

FIG. 2 a schematic view of an embodiment of a kitchen appliance according to the present application,

FIG. 3 a schematic view of a further embodiment of a kitchen appliance according to the present application,

FIG. 4a a schematic view of an embodiment of a pot of a kitchen appliance according to the present application,

FIG. 4b an enlarged view of a top pot contact of the pot shown in FIG. 4a,

FIG. 4c a schematic view of an embodiment of an exemplary accessory in the form of a lid of a kitchen appliance according to the present application,

FIG. 5a a schematic view of an embodiment of an accessory according to the present application in an operating position,

FIG. 5b a schematic view of an embodiment of an accessory according to the present application in a non-operating position,

FIG. 6 a schematic view of a further embodiment of a kitchen appliance according to the present application, and

FIG. 7 a diagram of an embodiment of a method according to the present application.

### DESCRIPTION OF THE INVENTION

In the following, similar reference signs are used for similar elements.

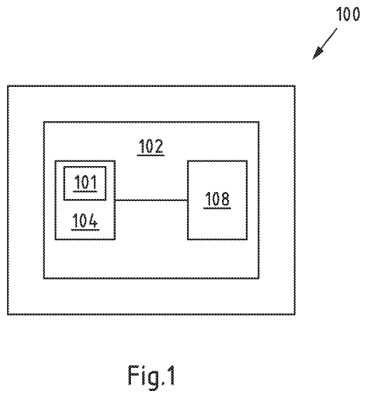

FIG. 1 shows a schematic view of an embodiment of an accessory 100 for a (not shown) kitchen appliance. The kitchen appliance is in particular a food processor configured to prepare food at least partially automatedly. As will be described in more detail, the kitchen appliance comprises a reading arrangement with a reading controller and at least one reading antenna connectable to the reading controller.

The accessory 100 is, for example, a varoma, stirring attachment, knife cover, measuring cup, lid, cooking basket or the like. The accessory 100 is directly or indirectly couplable to the kitchen appliance.

In particular, in order to be able to detect a correct positioning of the accessory 100 on respectively with respect to the kitchen appliance, that is, in particular, in order to be able to detect the operating position of the accessory 100, the accessory 100 comprises, according to the application, a transponder arrangement 102.

In particular, the transponder arrangement 102 is readable by the reading antenna at least in the operating position of the accessory 100. The transponder arrangement 102 comprises a transponder 104 and an accessory position sensor 108 coupled to the transponder 104. The accessory position sensor 108 is preferably an acceleration sensor 108. The accessory position sensor 108 is configured to detect at least one accessory position parameter (e.g., vertical axis angle, lateral axis angle, and/or longitudinal axis angle) of the accessory 100. Preferably, the accessory position sensor 108 may be configured to detect the angle of inclination of the accessory 100 with respect to the acceleration due to gravity.

The transponder 104 is preferably an RFID transponder 104. In particular, the accessory position sensor 108 may provide the transponder 104 with the (instantaneously) detected accessory position parameter and accessory position parameter value, respectively. For example, in the case of a passive transponder 104, the accessory position sensor 108 may be activated by the transponder 104 by providing power to the accessory position sensor 108 based on the received reading field of the reading antenna. Thereupon, the accessory position sensor 108 may provide the transponder 104 with the (instantaneously) detected accessory position parameter and accessory position parameter value, respectively. This is then transmitted by the transponder 104 to the reading arrangement. In particular, the transponder 104 may encode respectively manipulate the reading field according to the at least one (instantaneously) detected accessory position parameter. This can be decoded by the reading controller (in particular an RFID reader).

Optionally, the transponder 104 may comprise at least one readable memory 101. As has been described, the memory 101 may store at least one of an accessory identifier (such as a serial number or a Universally Unique Identifier (UUID)) and/or origin information (such as manufacturer identity, time of manufacture, place of manufacture, and/or authentication information) and/or an accessory type identifier and/or calibration information of the accessory position sensor 108. This could be stored prior to distribution, during or at the end of manufacturing, or during a dedicated calibration step. Corresponding data can be read in particular by the reading arrangement in addition to the (instantaneously) detected accessory position parameter.

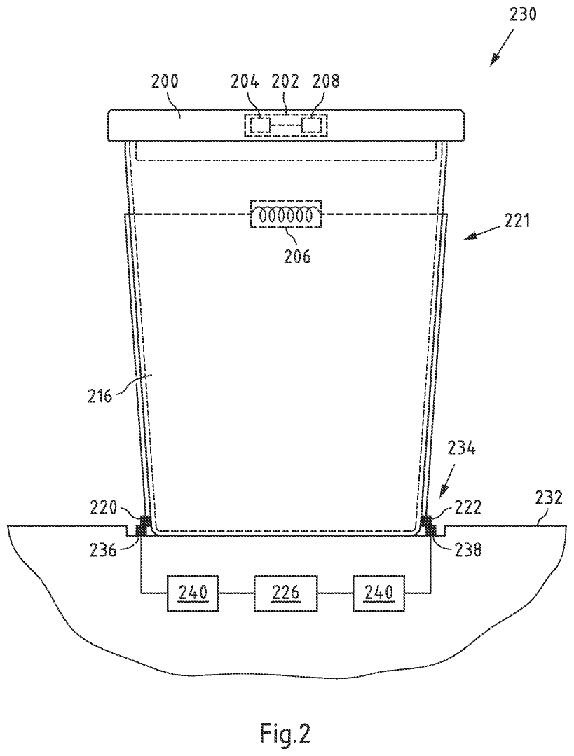

FIG. 2 shows a schematic view of an embodiment of a kitchen appliance 230 according to the present application. The kitchen appliance 230 comprises an appliance base 232, a pot 216, and a lid 200 as an accessory according to the application. It shall be understood that the pot is also an accessory and in variants of the application the pot may have a transponder arrangement according to the application.

In particular, the pot 216 and the lid 200 may form a container arrangement of the kitchen appliance 230. The pot 216 comprises a circumferential pot wall and a pot base.

The lid 200 is configured to close an opening of the pot 216. This closed state of the container arrangement is shown in FIG. 2. In particular, the lid 200 is in the locked position in FIG. 2. In particular, this means that the lid 200 is (correctly) mechanically locked to the pot 216, i.e. the container arrangement is in the locked state. In the present case, this is synonymous with the fact that the accessory 200 is in the operating position, i.e. in particular is positioned and arranged, respectively, ready for operation on the kitchen appliance 230.

In particular, the lid 200 is movable relative to the pot 216 between an unlocked position and a (defined) locked position. The locking mechanism may be, for example, a bayonet latch or similar mechanical latch.

The illustrated kitchen appliance 230 comprises an appliance base 232 having a pot receptacle 234. The pot receptacle 234 is configured to receive the pot 216, in particular at least the bottom of the pot. As can be seen, the pot receptacle 234 corresponds to the pot 216 of the container arrangement such that an electrical connection is established between a first lower electrical pot contact 220 and a first electrical base contact 236 of the appliance base 232, and an electrical connection is established between a second lower electrical pot contact 222 and a second electrical base contact 238 of the appliance base 232 when the pot 216 is (correctly) arranged in the pot receptacle 232.

The kitchen appliance 230 comprises a reading arrangement 221. The reading arrangement 221 comprises a reading controller 226, in particular an RFID reader, and a reading antenna 206, in particular an antenna coil. In the present embodiment, the reading controller 226 is connected to the first base contact 236 and the second base contact 238 via an optional filtering and matching network 240. In the present embodiment, the reading antenna 206 is connected to the first lower pot contact 220 and the second lower pot contact 222.

When the pot, 216, as shown, is arranged in the pot receptacle 234, the reading controller 226 may apply an antenna signal to the reading antenna 206 such that the reading antenna 206 emits a reading field.

The accessory 200 in the form of the lid 200 comprises a transponder arrangement 202. The transponder arrangement 202 can in particular be formed in the same way as the transponder arrangement according to FIG. 1 so that reference is made to the explanations regarding FIG. 1 in order to avoid repetitions.

In particular, the reading arrangement 221 is configured to read the transponder arrangement 202.

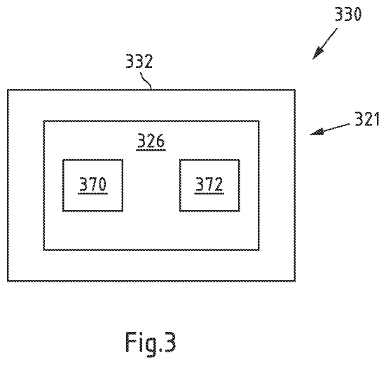

FIG. 3 shows a schematic view of a further embodiment of a kitchen appliance 330 according to the present application. Tin order to avoid repetitions, essentially only the differences to the previous embodiments are described below and otherwise reference is made to the previous embodiments. In particular, the illustration of an accessory has been omitted in favor of a better overview.

The reading controller 326 of the reading arrangement 321 comprises an evaluation module 370 and a kitchen appliance position sensor 372. The kitchen appliance position sensor 372 may be configured to detect a kitchen appliance position parameter. Preferably, the kitchen appliance position sensor 372 may be an acceleration sensor, in particular a 3-axis acceleration sensor. In particular, the axes may be the transverse axis, longitudinal axis, and vertical axis. Preferably, the at least one accessory position parameter may be an (instantaneous) angle of inclination of the kitchen appliance 330 (in particular the appliance base 332) with respect to the acceleration due to gravity. For example, the angle of inclination of the kitchen appliance 330 (in particular the appliance base 332) with respect to the acceleration due to gravity may be determined from a detected transverse axis angle, longitudinal axis angle, and/or vertical axis angle.

The evaluation module 370 may be configured to determine whether the accessory comprising the transponder arrangement is properly positioned and arranged, respectively, on the kitchen appliance 330. For this purpose, at least one accessory position parameter may be read from the transponder arrangement and, in particular, the at least one read accessory position parameter may be evaluated.

Preferably, the evaluation module 370 may compare the at least one read accessory position parameter (for example, an aforementioned angle, in particular an angle of inclination with respect to the acceleration due to gravity) with the operating position criterion. The operating position criterion may define when proper positioning is (or is not) present. For example, the operating position criterion may define a corresponding angular range. In particular, the angular range may be based on the at least one kitchen appliance position parameter (e.g., said angle of inclination). For example, the angular range may be a tolerance range lying around the instantaneous angle of inclination.

If the read angle (value) is within the angle range, the evaluation module 370 may determine that the accessory is properly positioned and arranged, respectively, on the kitchen appliance 330. If the read angle (value) is not within the angle range, the evaluation module 370 may determine that the accessory is not properly positioned and arranged, respectively, on the kitchen appliance 330.

As has already been described, the evaluation module 370 may additionally take into account further read data in the evaluation, such as an accessory identifier (such as a serial number or a Universally Unique Identifier (UUID)) and/or origin information (such as manufacturer identity, date of manufacture, place of manufacture, and/or authentication information) and/or an accessory type identifier and/or calibration information of the accessory and/or calibration information of the kitchen appliance 330, in particular the appliance base 332.

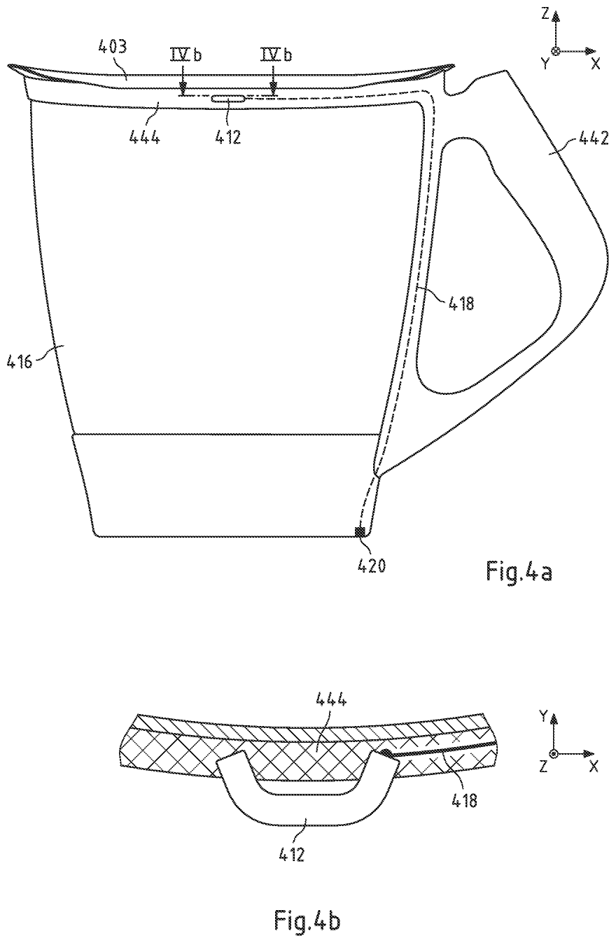

FIG. 4a shows a schematic side view of an embodiment of a pot 416 of a kitchen appliance according to the present application, and FIG. 4c shows a schematic top view of an embodiment of a lid 400 of the kitchen appliance structurally corresponding to the pot 416 according to the present application. FIG. 4b shows an enlarged section, in particular a top view, of the pot 416 according to FIG. 4a.

The pot 416 is preferably formed partially of metal and partially of plastic. In particular, a section 442 may be formed of plastic. This section 442 may also form the handle and may in particular comprise an at least partially, preferably completely, annular sub-section 443 arranged on the pot edge 403.

In the present embodiment, a first upper electrical pot contact 412 is arranged at the upper pot edge 403. Preferably, a second upper electrical pot contact (not shown) is arranged on the opposite side of the upper pot edge 403.

The first electrical pot connection 418 extends from the first upper electrical pot contact 412 in particular through the section 442 to the first lower pot contact 420. In particular, the first pot connection 418 may be integrated in the plastic section 442. In particular, the first lower pot contact 420 is arranged in respectively at the bottom of the pot. The further (not shown) pot connection may be formed accordingly.

The upper first pot contact 412 and the second pot contact are preferably embedded in the annular plastic subsection 443. This subsection 443 preferably comprises a portion of the locking mechanism of the container arrangement. In particular, the subsection 443 may comprise contours for locking the lid 400 to the pot 416 in the defined locking position.

As can be seen from the top view of the associated lid 400 in FIG. 4c, a first lid contact 411 and a second lid contact 413 are arranged on the lid 400, in particular on the outer lid edge 405.

In particular, the reading antenna 406 of the reading arrangement 421 of the kitchen appliance is an antenna coil 406. In particular, the antenna coil 406 may be formed by at least one winding 409, preferably a plurality of windings 409, as shown. In particular, the at least one winding 409 may be formed of a metal, preferably copper.

As can be seen from FIG. 4c, the at least one winding 409 extends in particular along the lid edge 405 respectively in the vicinity of the lid edge 405 from the first lid contact 411 to the second lid contact 413. The second lid contact 413 is located in particular on a side of the lid edge 405 opposite to the first lid contact 411.

The at least one winding 409 is preferably inserted into the lid base body during manufacturing and subsequently provided with a (not shown) cover (preferably formed of plastic), which can be attached to the lid base body, for example, by ultrasonic welding.

Preferably, the first lid contact 411 and the second lid contact 413 may be arranged on the lid 40 and relative to the upper pot contacts 412 such that an electrical connection between the first lid contact 411 and the first upper pot contact 412 and an electrical connection between the second lid contact 410 and the second upper pot contact are established only when the lid 400 is in the locked position. In other words, an antenna signal can only be applied to the reading antenna 406 by the reading controller system when the lid 400 is in the locked position. Only in the locked position the circuit is closed.

In the present embodiment, the respective connections between the lid contact and pot contact are contact-based connections.

In the present embodiment, the lid contacts 411, 413 and the upper pot contacts 412 are formed as exposed electrical contacts 411, 412, 413. Preferably, the lid contacts 411, 413 comprise a first longitudinal extension in a first direction and the respective associated upper pot contact 412 comprises a second longitudinal extension in a second direction. As can be seen, there is an angle of between 10° and 90° between the first and the second direction (which are located in particular in the same plane), in particular of approximately 90° in the present case.

When the lid 400 is moved from the unlocked position to the locked position (which can take place, for example, in the form of a rotary movement), the respective contacts 411, 412, 413 slide on each other or along one another in a contact-based manner. This can prevent impairment of the contact resistance at the respective contacts 411, 412, 413 since any impurities adhering to the contacts 411, 412, 413 are scraped off.

In addition, a back lining 444 with a resilient material (e.g., silicone) may be provided at the lid contact 411, 413 or pot contact 412.

Preferably, as an accessory the lid 400 further comprises a transponder arrangement 402. In other words, in a preferred embodiment, the transponder arrangement 402 and the reading antenna 406 of the reading arrangement 421 may be arranged in an accessory.

The transponder 404 is arranged within the range of the antenna coil 406. In particular, the transponder 408 is surrounded by the at least one winding 409. In one embodiment, there may be 3 or 4 windings.

The transponder associated with a pre-described accessory position sensor 408 comprises a second antenna coil 425. For example, the transponder arrangement 402 may be adhered. The transponder arrangement 402, in particular the antenna coil 425, may be covered by a not shown cover, for example made of plastic.

Instead of a respective electrical connection in contact-based manner, in general a contactless electrical connection can also be provided between a lid contact and a pot contact in each case.

The first lid contact may be formed as a first lid surface element (e.g., by a foil of an electrically conductive material, such as a metal foil) and the second lid contact may be formed as a second lid surface element (e.g., by a foil of an electrically conductive material, such as a metal foil).

The first upper pot contact may be formed as a first pot surface element (e.g., by a foil of an electrically conductive material, such as a metal foil), and the second upper pot contact (e.g., by a foil of an electrically conductive material, such as a metal foil) may be formed as a second pot surface element.

In a locked position of the lid, the first lid surface element and the first pot surface element may form a first coupling capacitor. The second lid surface element and the second pot surface element may form a second coupling capacitor.

In particular, said surface elements form a respective coupling capacitor only in the locked position of the lid. In other words, only in the locked position can the antenna signal provided by the reading controller be transmitted to the reading antenna (e.g., a (schematically indicated) antenna coil) via said coupling capacitors.

The dielectric of the respective coupling capacitor is defined in particular by air and/or the used plastic.

Finally, it should be noted that reference sign 450 denotes the vertical axis of accessory 400, reference sign 452 denotes the longitudinal axis of accessory 400, and reference sign 454 denotes the transverse axis of accessory 400.

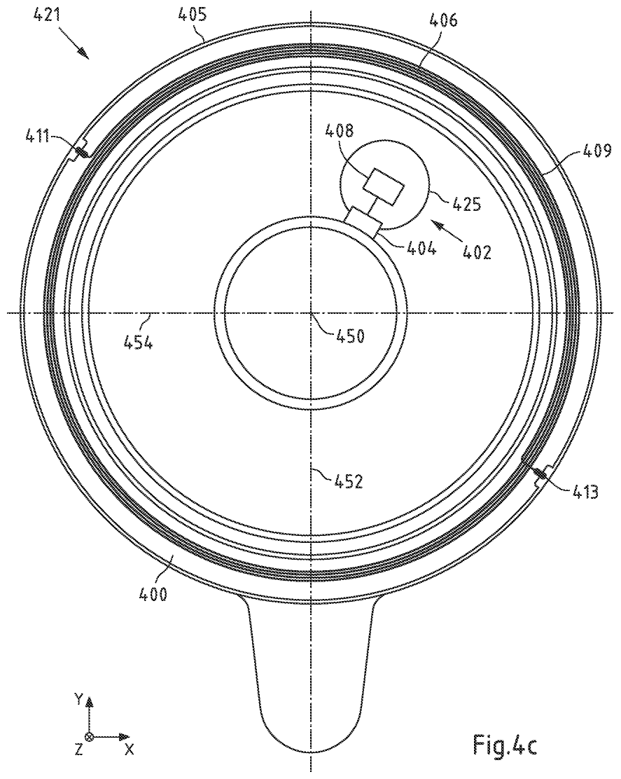

FIG. 5a shows a schematic view of an embodiment of an accessory 500.1 according to the present application in an operating position and FIG. 5b (in comparison to FIG. 5a) shows a schematic view of an embodiment of the accessory 500.1 in a non-operating position. In order to avoid repetitions, essentially only the differences from the previous embodiments are described below, and otherwise reference is made to the previous explanations. In particular, details (e.g. transponder arrangement) have been omitted in favor of a better overview.

As can be seen from FIG. 5a, the accessory 500.1 is operatively coupled to the kitchen appliance 530. Presently, the accessory 500.1 is coupled and connected, respectively, to the lid 500.2 of the kitchen appliance 530. In other words, the accessory 500.1 is in the operational position.

For example, pot 516 and lid 500.2 may be formed according to the pot and lid of FIG. 4.

In this case, the evaluation module of a reading arrangement will determine that, for example, the detected angle of inclination with respect to the acceleration due to gravity of the accessory 500.1 satisfies the operating position criterion. For example, the operating position criterion may be a detected angle of inclination with respect to the acceleration due to gravity of the kitchen appliance 530 (or a tolerance range around that angle of inclination). In particular, the operating position criterion is satisfied if the angle of inclination with respect to the acceleration due to gravity of the accessory 500.1 substantially corresponds to the angle of inclination with respect to the acceleration due to gravity of the kitchen appliance 500.1, i.e., in particular, lies within the angle range and tolerance range, respectively. This means in particular that the angle of inclination between the two sensors (within a tolerance range) becomes equal to zero.

In addition, an accessory type criterion and, if necessary, calibration information can be taken into account. In particular, at least one of the angles of inclination can be corrected and adjusted, respectively, by means of the accessory type criterion and/or calibration information.

In particular, the evaluation module can therefore determine the operating position of the accessory 500.1 based on the read accessory position parameter and an operating position criterion.

As can be seen from FIG. 5b, the accessory 500.1 is not properly respectively operably positioned on the kitchen appliance 530. Rather, the accessory 500.1 lies in the edge region of the lid 500.2 and thus, due to the undertaken design and/or structural measures, lies in an inclined manner on the accessory 500.1 and/or the further accessory 500.2. Thus, the accessory 500.1 is not coupled and positioned, respectively, correctly with the lid 500.2 of the kitchen appliance 530. In other words, the accessory 500.1 is in a non-operating position. In particular, proper operation is not possible in this position.

In this case, the evaluation module of a reading arrangement will determine that, for example, the detected angle of inclination with respect to the acceleration due to gravity of the accessory 500.1 does not satisfy the operating position criterion. For example, the operating position criterion may be a detected angle of inclination with respect to the acceleration due to gravity of the kitchen appliance 530 (or a tolerance range around this angle of inclination).

In particular, the operating position criterion is not met if the angle of inclination with respect to the acceleration due to gravity of the accessory 500.1 does not substantially correspond to the angle of inclination with respect to the acceleration due to gravity of the kitchen appliance 500.1, i.e., in particular, if it lies outside the angle range and tolerance range, respectively.

In addition, an accessory type criterion and, if necessary, calibration information can be taken into account. In particular, at least one of the angles of inclination can be corrected and adjusted, respectively, by means of the accessory type criterion and/or calibration information.

In particular, therefore, the evaluation module can determine the non-operating position of the accessory 500.1 based on the read accessory position parameter and an operating position criterion.

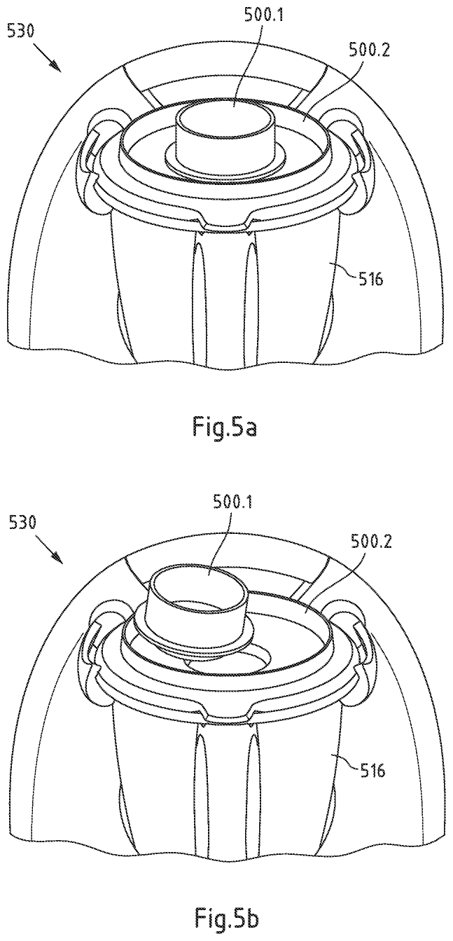

FIG. 6 shows a schematic view of a further embodiment of a kitchen appliance 630 according to the present application. In order to avoid repetitions, essentially only the differences to the previous embodiments are described below, and otherwise reference is made to the previous embodiments.

As can be seen, the appliance base 632 comprises a tool drive 660. The tool drive 660 is configured to drive respectively operate an (accessory in the form of) a kitchen appliance tool 662, which may in particular be located in the pot 616. Exemplarily, a kitchen appliance tool 662 is shown as a cutting tool 662. Further, the kitchen base may comprise a control device that controls and monitors the heater that is integrated in the pot 602.

An accessory 600.1 in the form of a stirring attachment 600.1 is positioned on respectively at the kitchen appliance tool 662. As shown, the accessory 600.1 is correctly positioned respectively presently coupled to the kitchen appliance tool 662 (and thus to the kitchen appliance 630). In particular, the shown accessory 600.1 is in an operating position.

As can be seen, the kitchen appliance 630 comprises a further accessory 600.2 in the form of a lid 600.2. Pot 616 and lid 600.2 may be formed, for example, according to the pot and lid of FIGS. 4a and 4b.

In particular, the reading controller 626 comprises an evaluation module 670 and a kitchen appliance position sensor 672. In particular, the evaluation module 670 is configured to detect respectively determine the operating position respectively an operating state of the accessories 600.1, 600.2 based on the data (at least the respective currently detected accessory position parameters) read from the transponder arrangements 602.1, 602.2 in each case.

For example, the lid 600.2 may be moved to the locked position by a user. Once the lid 600.2 is in the locked position, an electrical connection is established between the first lid contact 611 and the first upper pot contact 612, and an electrical connection is established between the second lid contact 613 and the second upper pot contact 614. An antenna signal is applied to the reading antenna 606 by the reading controller 626 via the established connections such that in particular a reading field is generated and transmitted.

The transponders 604.1, 604.2 arranged within range receive the reading field and in particular extract the instructions contained therein. Based on the instructions, the respective transponder 604.1, 604.2 generates a response. For example, the respective transponder 604.1, 604.2 outputs the respective instantaneously detected accessory position parameters and optionally the respective stored data, such as an accessory identifier and/or an origin information and/or an accessory type identifier and/or a calibration information of the respective accessory position sensor 608.1, 608.2. In particular, the respective transponder 604.1, 604.2 influences the reading field accordingly. This can be detected by the reading controller 626 so that said data is read.

In the manner described above, an operating position or a non-operating position of the accessories 600.1, 600.2 can be determined.

Furthermore, the appliance base 632 comprises a releasing module 674. The releasing module 674 is in particular configured to release at least one device function in particular depending on the accessory type of the at least one accessory 600.1, 600.2 (properly) positioned at the appliance base 632 and/or at a further accessory. The releasing module 674 can in particular be communicatively connected to the evaluation module 670. If no properly positioned accessory is detected, the at least one device function may remain disabled.

Preferably, the evaluation module 670 may additionally be configured to determine the accessory type based on the read data, in particular the accessory type identifier and a stored accessory type criterion. Preferably, the accessory type criterion may be an assignment table described above. In particular, the assignment table can additionally store for each accessory type the at least one device function permitted for this accessory type.

Exemplary and non-exhaustive kitchen appliance functions respectively device functions are: A first cutting function with a first maximum permissible set speed and/or set torque, a further cutting function with a second (different from the first maximum permissible set speed and/or set torque) maximum permissible set speed and/or set torque, a first stirring function with a first maximum permissible set speed and/or set torque, a further stirring function with a second (different from the first maximum permissible set speed and/or set torque) maximum permissible set speed and/or set torque, a first motor direction of rotation, a second opposite motor direction of rotation, a first set temperature (or heating power) and/or a second set temperature (or heating power) and/or a second set temperature (or heating power). a first set temperature range (or heating power range) of a heater integrated in the food receptable element, a second set temperature (differing from the first set temperature) and/or a second set temperature range (differing from the first set temperature range) of a heater integrated in the food receptable element, control programs and/or control program set parameters for specific operations, etc.

In particular, after determining the accessory type of the at least one arranged accessory 600.1, 600.2, the at least one device function permitted for this accessory type can be released by the releasing module 674. The accessory type and optionally the permissible device function can be determined in particular by comparing the read accessory type identifier with the accessory type identifiers stored in the assignment table.

If the allowable device function comprises a maximum allowable drive set parameter value, a releasing of a device function may comprise, in particular, limiting, for example by the releasing module 674, the operation of the tool drive 660 to the drive set parameter value stored for that accessory type (e.g., a maximum allowable set speed and/or torque).

Optionally, the kitchen device 630 may have a (visual) screen 666, such as a display. The display 666 may be configured to display the identified accessory type. Optionally, an error message (for example, if an operating position and coupling condition, respectively, was detected but no accessory type could be determined, or if a non-operating position and non-coupling condition, respectively, was detected) and/or an advisory message (for example, a request for cleaning) may be displayed.

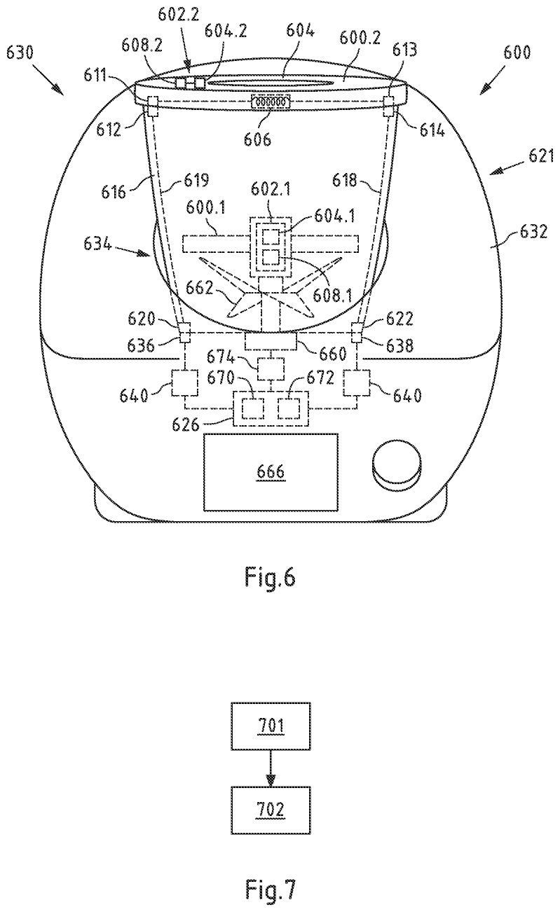

The operation of a kitchen appliance, such as the kitchen appliance 630, is described in more detail below with the aid of FIG. 7. FIG. 7 shows a diagram of an embodiment of a method according to the present application. The method is used to detect respectively determine the operating position of an accessory.

In a step 701, a reading is performed, by a reading arrangement of the kitchen appliance, of the accessory position parameter of the accessory detected by the accessory position sensor, as has already been described.

In a further step 702, a determining is performed, by an evaluation module of the reading arrangement, of an operating position of the accessory based on the read accessory position parameter and an operating position criterion.

### LIST OF REFERENCE SIGNS

100, 200, 400, 500, 600 accessory
101 memory
102, 202, 402, 602 transponder arrangement
403 pot edge
104, 204, 404, 604 transponder
405 lid edge
106, 206, 306, 406, 606 reading antenna
108, 208, 408, 608 accessory position sensor
409 winding
411, 611 first lid contact
412, 612 first upper pot contact
413, 613 second lid contact
614 second upper pot contact
216, 416, 516, 616 pot
418, 618 first pot connection
619 second pot connection
220, 420, 620 first lower pot contact
221, 321, 421, 621 reading arrangement
622 second lower pot contact
425 antenna coil
226, 326, 626 reading controller
230, 330, 530, 630 kitchen appliance
232, 332, 632 appliance base
234, 634 pot receptable
236, 636 first base contact
238, 638 second base contact
240, 640 filter and adjustment network
442 pot section
443 ring-shaped section of the pot section
444 back lining
450 vertical axis
452 longitudinal axis
454 transverse axis
660 tool drive
662 kitchen appliance tool
666 display
370, 670 evaluation module
372, 672 kitchen appliance position sensor
674 releasing module

1. An accessory for a kitchen appliance, wherein the kitchen appliance comprises a reading arrangement having a reading controller and at least one reading antenna connectable to the reading controller, wherein the accessory comprises:
at least one transponder arrangement,
wherein the transponder arrangement comprises a transponder and an accessory position sensor connected to the transponder,
wherein the accessory position sensor is configured to detect at least one accessory position parameter of the accessory, and
wherein the transponder arrangement is configured to transmit the detected accessory position parameter to the reading arrangement.

2. The accessory according to claim 1, wherein
the transponder is an RFID transponder.

3. The accessory according to claim 1, wherein
the transponder is a passive transponder.

4. The accessory according to claim 3, wherein
the transponder is configured to provide electrical power to the accessory position sensor based on a received reading field of the reading antenna.

5. The accessory according to claim 4, wherein
the transponder comprises at least one readable memory,
wherein at least one accessory identifier and/or accessory type identifier is/are stored in the memory.

6. The accessory according to claim 5, wherein
the transponder comprises at least one readable memory,
wherein at least one calibration information of the accessory position sensor is stored in the memory.

7. The accessory according to claim 6, wherein
the accessory position sensor is an acceleration sensor, in particular a 3-axis acceleration sensor,
and/or
the accessory position parameter is an angle of inclination of the accessory with respect to the acceleration due to gravity.

8. The kitchen appliance, comprising:
at least one accessory according to claim 7, and
a reading arrangement comprising a reading controller and at least one reading antenna connectable to the reading controller.

9. The kitchen appliance of claim 8, wherein the kitchen appliance further comprises:
an appliance base, and
at least one container arrangement,
wherein the appliance base and/or the container arrangement comprises the reading arrangement, and
the reading arrangement is configured to at least read the accessory position parameter from the transponder arrangement.

10. The kitchen appliance according to claim 8, wherein
the reading controller is configured to apply an antenna signal to the reading antenna so that a reading field is transmitted by the reading antenna.

11. The kitchen appliance according to claim 8, wherein
the reading controller comprises an evaluation module configured to determine an operating position of the accessory based on the read accessory position parameter and an operating position criterion.

12. The kitchen appliance according to claim 11, wherein
the kitchen appliance comprises at least one kitchen appliance position sensor configured to detect a kitchen appliance position parameter,
where the operating position criterion is based on the detected kitchen appliance position parameter.

13. The kitchen appliance according to claim 12, wherein
the evaluation module is configured to compare the accessory position parameter with the kitchen appliance position parameter, and
the evaluation module is configured to determine the operating position of the accessory based on the comparison result.

14. The kitchen appliance according to claim 11, wherein
the reading arrangement is configured at least to read the accessory identifier and/or the accessory type identifier from the transponder arrangement, and
the evaluation module is configured to determine the operating position of the accessory based on the accessory identifier and/or the accessory type identifier.

15. The method of determining the operating position of an accessory according to claim 1, comprising:
reading, by a reading arrangement of a kitchen appliance, the accessory position parameter of the accessory detected by the accessory position sensor, and
determining, by an evaluation module of the reading arrangement, an operating position of the accessory based on the read accessory position parameter and an operating position criterion.

16. An Accessory according to claim 7, wherein
the an acceleration sensor is a 3-axis acceleration sensor.
